(19) United States
(12) Patent Application Publication
(10) Pub. No.: US 2023/0086177 A1
(43) Pub. Date: Mar. 23, 2023

(54) PROCESS FOR PREPARING POLYETHER CARBONATE POLYOLS

(71) Applicant: Covestro Deutschland AG, Leverkusen (DE)

(72) Inventors: Marcel Langer, Bad Schönborn (DE); Michael Pohl, Aachen (DE); Muhammad Afzal Subhani, Aachen (DE)

(21) Appl. No.: 17/793,796

(22) PCT Filed: Mar. 4, 2021
(86) PCT No.: PCT/EP2021/055507

§ 371 Date: Jul. 19, 2022

(30) Foreign Application Priority Data
Mar. 10, 2020 (EP) 20161952.5

(51) Int. Cl. C08G 64/18; C08G 18/44; C08G 64/34; C08G 18/48; C08J 9/12

(52) U.S. Cl. CPC C08G 64/183; C08G 18/44; C08G 64/34; C08G 18/4866; C08J 9/122; C08G 2101/00

(57) ABSTRACT

The present invention relates to a method for preparing polyether carbonate polyols by adding alkylene oxide and carbon dioxide to a H-functional starter substance in the presence of a DMC catalyst or a metal complex catalyst based on the metals cobalt and/or zinc, wherein (γ) alkylene oxide and carbon dioxide are added to a H-functional starter substance in a reactor in the presence of a DMC catalyst or a metal complex catalyst based on the metals cobalt and/or zinc, characterized in that the alkylene oxide contains a proportion of 5 to 50 wt. % ethylene oxide, based on the overall weight of the alkylene oxide used, and the addition of the ethylene oxide is carried out in an atmosphere containing carbon dioxide.

### CROSS REFERENCE TO RELATED APPLICATIONS

This application is a U.S. national stage application, filed under 35 U.S.C. § 371, of International Application No. PCT/EP2021/055507, which was filed on Mar. 4, 2021, which claims priority to European Patent Application No. 20161952.5, which was filed on Mar. 10, 2020. The contents of each are hereby incorporated by reference into this specification.

### FIELD

The present invention relates to a process for preparing polyethercarbonate polyols, to the polyethercarbonate polyols obtainable by this process, and to the use of these polyethercarbonate polyols in the production of polyurethane plastics, particularly polyurethane foams.

### BACKGROUND

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al, Copolymerization of Carbon Dioxide and Epoxide with Organometallic Compounds; Die Makromolekulare Chemie [Macromolecular Chemistry] 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are integers, and where the product shown here in scheme (I) for the polyethercarbonate polyol should merely be understood in such a way that blocks having the structure shown may in principle be present in the polyethercarbonate polyol obtained, but the sequence, number and length of the blocks and the OH functionality of the starter may vary and is not restricted to the polyethercarbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R═CH₃, propylene carbonate).

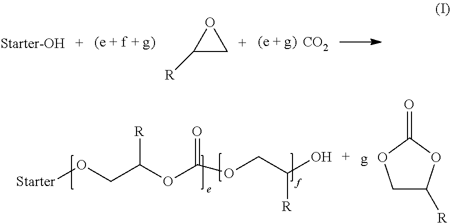

WO-A 2001/044347 discloses a process for the DMC-catalyzed preparation of polyether polyols, in which at least two different epoxides are metered in together, the ratio of the epoxides to one another in the mixture being changed during the joint metered addition.

WO-A 2008/058913 discloses a process for preparing flexible polyurethane foams using polyethercarbonate polyols produced by means of DMC catalysis, the polyethercarbonate polyols preferably having a block of pure alkylene oxide units, in particular pure propylene oxide units, at the chain end.

WO-A 2014/072336 discloses a process for the DMC-catalyzed preparation of polyethercarbonate polyols. In a first step, polyethercarbonate polyols are prepared and, in further steps, chain-extended with mixtures of propylene oxide and ethylene oxide, the proportion of ethylene oxide being increased in each case.

### SUMMARY

The object of the present invention is to provide a process for preparing polyethercarbonate polyols having an increased proportion of primary OH groups.

It has been found that, surprisingly, the object of the invention is achieved by a process for preparing polyethercarbonate polyols by addition of alkylene oxide and carbon dioxide onto an H-functional starter substance in the presence of a DMC catalyst or of a metal complex catalyst based on the metals cobalt and/or zinc, wherein
(γ) alkylene oxide and carbon dioxide are added to an H-functional starter substance in a reactor in the presence of a DMC catalyst or a metal complex catalyst based on the metals cobalt and/or zinc,
   characterized in that the alkylene oxide comprises a proportion of from 5 to 50% by weight ethylene oxide, based on the total weight of the alkylene oxide used, and the addition of the ethylene oxide is carried out under a carbon dioxide-containing atmosphere.

### DETAILED DESCRIPTION

In a particular embodiment, the process according to the invention also results in polyethercarbonate polyols having reduced viscosity.

Step (α):

In the process according to the invention, it is possible first to initially charge the reactor with H-functional starter substance and/or a suspension medium containing no H-functional groups, preference being given to initially charging a portion of the H-functional starter substance. Subsequently, the amount of catalyst required for the polyaddition is added to the reactor. The sequence of addition is not critical. It is also possible to charge the reactor firstly with the catalyst and subsequently with the suspension medium. Alternatively, it is also possible first to suspend the catalyst in the inert suspension medium and then to introduce the suspension into the reactor. The suspension medium provides a sufficient heat transfer area with the reactor wall or cooling elements installed in the reactor, such that the heat of reaction released can be removed very efficiently. Moreover, the suspension medium, in the event of a cooling failure, provides heat capacity, such that the temperature in this case can be kept below the breakdown temperature of the reaction mixture.

The suspension media used according to the invention do not comprise any H-functional groups. Suitable suspension media include all polar aprotic, weakly polar aprotic and non-polar aprotic solvents, none of which contain any H-functional groups. Suspension media used may also be a mixture of two or more of these suspension media. Mention is made by way of example at this point of the following polar aprotic solvents: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

Likewise suitable as suspension media used in accordance with the invention are aliphatic lactones, aromatic lactones, lactides, cyclic carbonates having at least three optionally substituted methylene groups between the oxygen atoms of the carbonate group, aliphatic cyclic anhydrides and aromatic cyclic anhydrides.

Aliphatic or aromatic lactones in the context of the invention are cyclic compounds containing an ester bond in the ring, preferably

4-membered lactone rings such as β-propiolactone, β-butyrolactone, β-isovalerolactone, β-caprolactone, β-isocaprolactone, β-methyl-β-valerolactone,

5-membered lactone rings such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one,

6-membered lactone rings such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one,

7-membered lactone rings such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yDoxepan-2-one, 4-methyl-7-(propan-2-yl)oxepan-2-one,

lactone rings having higher numbers of members, such as (7E)-oxacycloheptadec-7-en-2-one.

Particular preference is given to ε-caprolactone and dihydrocoumarin.

Lactides in the context of the invention are cyclic compounds containing two or more ester bonds in the ring, preferably glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-dione, 3,6-di(but-3-en-1-yl)-1,4-dioxane-2,5-dione (in each case including optically active forms). Particular preference is given to L-lactide.

Cyclic carbonates having at least three optionally substituted methylene groups between the oxygen atoms of the carbonate group are preferably trimethylene carbonate, neopentyl glycol carbonate (5,5-dimethyl-1,3-dioxan-2-one), 2,2,4-trimethylpentane-1,3-diol carbonate, 2,2-dimethylbutane-1,3-diol carbonate, butane-1,3-diol carbonate, 2-methylpropane-1,3-diol carbonate, pentane-2,4-diol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-dioxan-2-one, 5-methyl-5-propyl-1,3-dioxan-2-one, 5-(phenylamino)-1,3-dioxan-2-one and 5,5-dipropyl-1,3-dioxan-2-one. Particular preference is given to trimethylene carbonate and neopentyl glycol carbonate.

Cyclic anhydrides are preferably succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3[(2E)-but-2-en-1-yl]dihydrofuran-2,5-dione. Particular preference is given to succinic anhydride, maleic anhydride and phthalic anhydride.

The suspension medium used may also be a mixture of two or more of the suspension media mentioned. Most preferably, the suspension medium used in step (α) is at least one compound selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, carbon tetrachloride, ε-caprolactone, dihydrocoumarin, trimethylene carbonate, neopentyl glycol carbonate, 3,6-dimethyl-1,4-dioxane-2,5-dione, succinic anhydride, maleic anhydride and phthalic anhydride.

In one embodiment of the invention, in step (α), a suspension medium containing no H-functional groups is initially charged in the reactor, optionally together with catalyst, without including any H-functional starter substance in the initial reactor charge. Alternatively, it is also possible in step (α) to initially charge the reactor with a suspension medium containing no H-functional groups, and additionally with a portion of the H-functional starter substance(s) and optionally with catalyst.

The catalyst is preferably used in an amount such that the content of catalyst in the reaction product resulting from step (γ) is 10 to 10 000 ppm, particularly preferably 20 to 5000 ppm and most preferably 50 to 500 ppm.

In a preferred embodiment, in step (α), inert gas (for example argon or nitrogen), an inert gas/carbon dioxide mixture or carbon dioxide is introduced into the resulting mixture (i) of a portion of the H-functional starter substance and/or suspension medium and (ii) catalyst at a temperature of 90° C. to 150° C., particularly preferably of 100° C. to 140° C., and at the same time a reduced pressure (absolute) of 10 mbar to 800 mbar, particularly preferably of 50 mbar to 200 mbar, is applied.

In an alternative preferred embodiment, in step (α), the resulting mixture (i) of a portion of the H-functional starter substance(s) and/or suspension medium and (ii) catalyst is contacted at least once, preferably three times, at a temperature of 90° C. to 150° C., particularly preferably of 100° C. to 140° C., with 1.5 bar to 10 bar (absolute), particularly preferably 3 bar to 6 bar (absolute), of an inert gas (for example argon or nitrogen), an inert gas/carbon dioxide mixture or carbon dioxide and then the gauge pressure is reduced in each case to about 1 bar (absolute).

The catalyst can be added in solid form or as a suspension in a suspension medium or in a mixture of at least two suspension media.

In a further preferred embodiment, in step (α),
(α-I) a portion of the H-functional starter substance and/or suspension medium is initially charged and
(α-II) the temperature of the portion of the H-functional starter substance and/or the suspension medium is brought to 50 to 200° C., preferably 80 to 160° C., particularly preferably 100 to 140° C., and/or the pressure in the reactor is lowered to less than 500 mbar, preferably 5 mbar to 100 mbar, in the course of which an inert gas stream (for example of argon or nitrogen), an inert gas/carbon dioxide stream or a carbon dioxide stream is optionally passed through the reactor,

wherein the catalyst is added to the portion of the H-functional starter substance and/or suspension medium in step (α-I) or immediately thereafter in step (α-II), and

wherein the suspension medium contains no H-functional groups.

Step (β):

Step (β) serves to activate the DMC catalyst and thus relates to the embodiment of the process according to the invention in the presence of a DMC catalyst. This step (β) is preferably conducted under a carbon dioxide atmosphere. Activation in the context of this invention refers to a step wherein a portion of alkylene oxide is added to the DMC catalyst suspension at temperatures of 90° C. to 150° C. and the addition of the alkylene oxide is then interrupted, a subsequent exothermic chemical reaction causing an evolution of heat to be observed which can lead to a temperature spike (“hotspot”) and the conversion of alkylene oxide and optionally CO₂ causing a pressure drop to be observed in the reactor. The process step of activation is the period of time from the addition of the portion of alkylene oxide, optionally in the presence of CO₂, to the DMC catalyst until the occurrence of the evolution of heat. Optionally, the portion of the alkylene oxide can be added to the DMC catalyst in a plurality of individual steps, optionally in the presence of CO₂, and then the addition of the alkylene oxide can be stopped in each case. In this case the process step of activation comprises the period from addition of the first portion of alkylene oxide, optionally in the presence of CO₂, to the DMC catalyst until evolution of heat occurs after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be commenced from the vacuum or at a previously chosen supply pressure. The supply pressure is preferably established by introduction of carbon dioxide, where the pressure (in absolute terms) is 5 mbar to 100 bar, preferably 10 mbar to 50 bar and more preferably 20 mbar to 50 bar.

In a preferred embodiment, the amount of alkylene oxide used in the activation in step (β) is 0.1% to 25.0% by weight, preferably 1.0% to 20.0% by weight, more preferably 2.0% to 16.0% by weight (based on the amount of suspension medium used in step (α)). The alkylene oxide can be added in one step or portionwise in two or more portions. Preferably, addition of a portion of the alkylene oxide is followed by interruption of the addition of the alkylene oxide until the occurrence of evolution of heat, and only then is the next portion of alkylene oxide added.

Step (γ):

According to the invention, alkylene oxide comprising a proportion of 5 to 50% by weight of ethylene oxide, based on the total weight of the alkylene oxide used, is added onto the H-functional starter substance under a carbon dioxide-containing atmosphere. This results in EO/CO₂ groups being present in the polyol. The alkylene oxide can be metered in as a mixture or as individual constituents.

The metered addition of the carbon dioxide, of the alkylene oxide and optionally also of the H-functional starter substance can be effected simultaneously or sequentially (in portions); for example, it is possible to add the total amount of carbon dioxide, the amount of H-functional starter substances and/or the amount of alkylene oxide metered in in step (γ) all at once or continuously. It should be taken into account here that H-functional starter substance is used in at least one of steps (α) and (γ). The term “continuous” as used here can be defined as a mode of addition of a reactant such that a concentration of the reactant effective for the terpolymerization is maintained, meaning that, for example, the metered addition can be effected at a constant metering rate, with a varying metering rate or in portions.

It is possible, during the addition of the alkylene oxide and/or the H-functional starter substances, to increase or lower the CO₂ pressure gradually or stepwise or to leave it constant. The total pressure is preferably kept constant during the reaction by metered addition of further carbon dioxide. The metered addition of alkylene oxide and/or of H-functional starter substance is effected simultaneously or sequentially with respect to the metered addition of carbon dioxide. It is possible to effect metered addition of alkylene oxide at a constant addition rate or to increase or lower the addition rate gradually or stepwise or to add the alkylene oxide in portions. The alkylene oxide is preferably added to the reaction mixture at a constant addition rate. The metered addition of the alkylene oxide or the H-functional starter substance can be effected simultaneously or sequentially (in portions) via separate feeds (additions) in each case or via one or more feeds, in which case the alkylene oxide or the H-functional starter substance can be metered in individually or as a mixture. It is possible to synthesize random, alternating, block-type or gradient-type polyethercarbonate polyols via the type and/or sequence of metered addition of the H-functional starter substance and the alkylene oxide.

In a preferred embodiment, in step (γ), the metered addition of the H-functional starter substance is ended at a juncture prior to the addition of the alkylene oxide.

Preferably, an excess of carbon dioxide is used, based on the calculated amount of carbon dioxide incorporated in the polyethercarbonate polyol, since an excess of carbon dioxide is advantageous because of the low reactivity of carbon dioxide. The amount of carbon dioxide can be fixed via the total pressure (in absolute terms) (in the context of the invention, the total pressure (in absolute terms) is defined as the sum total of the partial pressures of the alkylene oxide and carbon dioxide used) under the particular reaction conditions. An advantageous total pressure (absolute) for the terpolymerization for preparing the polyethercarbonate polyols has been found to be in the range from 2.5 to 100 bar, preferably 4 to 50 bar, particularly preferably from 8 to 30 bar. The carbon dioxide may be supplied continuously or discontinuously. This depends on how rapidly the alkylene oxide is consumed. The amount of the carbon dioxide (reported as pressure) can likewise vary in the course of addition of the alkylene oxide. CO₂ can also be added to the reactor as a solid and then converted to the gaseous state under the selected reaction conditions.

One feature of a preferred embodiment of the process of the invention is that in step (γ) the entire amount of the H-functional starter substance is added. This addition can be effected at a constant metering rate, with a varying metering rate, or in portions.

For the process according to the invention, it has additionally been shown that the terpolymerization (step (γ)) for preparation of the polyethercarbonate polyols is conducted advantageously at 50° C. to 150° C., preferably at 60° C. to 145° C., particularly preferably at 70° C. to 140° C. and especially preferably at 90° C. to 130° C. If temperatures are set below 50° C., the reaction generally becomes very slow. At temperatures above 150° C., the amount of unwanted by-products rises significantly.

The metered addition of the alkylene oxide, the H-functional starter substance and the catalyst may be effected via separate or common feed points. In a preferred embodiment, alkylene oxide and H-functional starter substance are continuously supplied to the reaction mixture via separate feed points. This addition of the H-functional starter substance can be effected in the form of a continuous metered addition to the reactor or as portions.

Steps (α), (β) and (γ) can be carried out in the same reactor, or each can be carried out separately in different reactors. Particularly preferred reactor types are: tubular reactors, stirred tanks, loop reactors.

Polyethercarbonate polyols can be prepared in a stirred tank, in which case the stirred tank, according to the design and mode of operation, is cooled via the reactor jacket, internal cooling surfaces and/or cooling surfaces within a pumped circulation system. Both in semi-batchwise application, in which the product is not removed until after the end of the reaction, and in continuous application, in which the product is removed continuously, particular attention should be paid to the metering rate of the alkylene oxide. This should be set such that, in spite of the inhibiting action of the carbon dioxide, the alkylene oxide reacts sufficiently quickly. The concentration of free alkylene oxide in the reaction mixture during the activation step (step β) is preferably >0% to 100% by weight, particularly preferably >0% to 50% by weight, most preferably >0% to 20% by weight (based in each case on the weight of the reaction mixture). The concentration of free alkylene oxide in the reaction mixture during the reaction (step y) is preferably >0% to 40% by weight, particularly preferably >0% to 25% by weight, most preferably >0% to 15% by weight (based in each case on the weight of the reaction mixture).

In a preferred embodiment, the mixture containing activated DMC catalyst that results from steps (α) and (β) is reacted further in the same reactor with alkylene oxide, H-functional starter substance and carbon dioxide. In a further preferred embodiment, the mixture containing activated DMC catalyst that results from steps (α) and (β) is reacted further with alkylene oxide, H-functional starter substance and carbon dioxide in another reaction vessel (for example a stirred tank, tubular reactor or loop reactor).

When conducting the reaction in a tubular reactor, the mixture containing activated DMC catalyst that results from steps (α) and (β), the H-functional starter substance, alkylene oxide and carbon dioxide are pumped continuously through a tube. The molar ratios of the co-reactants are varied according to the desired polymer. In a preferred embodiment, carbon dioxide is metered in in its liquid or supercritical form to achieve optimal miscibility of the components. It is advantageous to install mixing elements for better mixing of the co-reactants, such as are marketed for example by Ehrfeld Mikrotechnik BTS GmbH, or mixer-heat exchanger elements which simultaneously improve mixing and heat removal.

Loop reactors can likewise be used for preparation of polyethercarbonate polyols. These generally include reactors with recycling, for example a jet loop reactor, which can also be operated continuously, or a loop-shaped tubular reactor with suitable apparatuses for circulation of the reaction mixture or a loop of a plurality of serially connected tubular reactors. The use of a loop reactor is thus advantageous especially because backmixing can be achieved here, such that it is possible to keep the concentration of free alkylene oxide in the reaction mixture within the optimal range, preferably in the range from >0% to 40% by weight, more preferably >0% to 25% by weight, most preferably >0% to 15% by weight (based in each case on the weight of the reaction mixture).

The polyethercarbonate polyols are preferably prepared in a continuous process which comprises both continuous terpolymerization and continuous addition of an H-functional starter substance.

The invention therefore also provides a process wherein, in step (γ), H-functional starter substance, alkylene oxide and catalyst are continuously metered into the reactor in the presence of carbon dioxide (“terpolymerization”) and wherein the resulting reaction mixture (containing the reaction product) is continuously removed from the reactor. Preferably, in step (γ), the catalyst is added continuously in suspension in H-functional starter substance.

For example, for the continuous process for preparing the polyethercarbonate polyols in steps (α) and (β), a mixture containing activated DMC catalyst is prepared, then, in step (γ),
(γ1) a portion each of H-functional starter substance, alkylene oxide and carbon dioxide are metered in to initiate the terpolymerization, and
(γ2) during the progress of the terpolymerization, the remaining amount of each of DMC catalyst, H-functional starter substance and alkylene oxide is metered in continuously in the presence of carbon dioxide, with simultaneous continuous removal of resulting reaction mixture from the reactor.

In step (γ), the DMC catalyst is preferably added in a suspension in the H-functional starter substance, the amount preferably being chosen such that the content of DMC catalyst in the reaction product resulting in step (γ) is 10 to 10 000 ppm, particularly preferably 20 to 5000 ppm and most preferably 50 to 500 ppm.

It is preferable when steps (α) and (β) are carried out in a first reactor, and the resulting reaction mixture is then transferred to a second reactor for the terpolymerization according to step (γ). However, it is also possible to carry out steps (α), (β) and (γ) in one reactor.

Step (δ)

In the optional step (δ), the reaction mixture obtained in step (γ), generally comprising a content of 0.05% by weight to 10% by weight alkylene oxide, can be subjected to a postreaction in the reactor or can be continuously transferred into a postreactor for postreaction, with reduction of the free alkylene oxide content by way of postreaction. In step (δ), by way of postreaction, the free alkylene oxide content is preferably reduced to less than 0.5 g/L, particularly preferably to less than 0.1 g/L, in the reaction mixture.

When the reaction mixture obtained in step (γ) remains in the reactor, the reaction mixture is preferably kept at a temperature of 60° C. to 140° C. for 10 min to 24 h, particularly preferably at a temperature of 80° C. to 130° C. for 1 h to 12 h, for postreaction. The reaction mixture is preferably stirred for this period until the free alkylene oxide content has fallen to less than 0.5 g/l, more preferably to less than 0.1 g/l, in the reaction mixture. The consumption of free alkylene oxide and optionally carbon dioxide generally causes the pressure in the reactor to fall during the postreaction in step (δ) until a constant value has been achieved.

The postreactor used may, for example, be a tubular reactor, a loop reactor or a stirred tank. The pressure in this postreactor is preferably at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 50° C. to 150° C. and more preferably 80° C. to 140° C.

The postreactor used is preferably a tubular reactor, it being possible to use, for example, a single tubular reactor or else a cascade of a plurality of tubular reactors arranged in parallel or in a linear series arrangement. The dwell time in the tubular reactor is preferably between 5 min and 10 h, more preferably between 10 min and 5 h.

DMC Catalyst:

Preference is given to using a DMC catalyst as the catalyst for the process according to the invention.

DMC catalysts for use in the homopolymerization of alkylene oxides are known in principle from the prior art (see, for example, U.S. Pat. No. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyethercarbonate polyols at very low catalyst concentrations, such that there is generally no need to separate the catalyst from the finished product. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by
(i) reacting an aqueous solution of a metal salt with the aqueous solution of a metal cyanide salt in the presence of one or more organic complex ligands, e.g. an ether or alcohol, in the first step,
(ii) removing the solid from the suspension obtained from (i) by known techniques (such as centrifugation or filtration) in the second step,
(iii) optionally washing the isolated solid with an aqueous solution of an organic complex ligand (for example by resuspending and subsequent reisolating by filtration or centrifugation) in a third step,
(iv) subsequently drying the solid obtained at temperatures of in general 20-120° C. and at pressures of in general 0.1 mbar to atmospheric pressure (1013 mbar), optionally after pulverizing,

and wherein, in the first step or immediately after the precipitation of the double metal cyanide compound (second step), one or more organic complex ligands, preferably in excess (based on the double metal cyanide compound), and optionally further complex-forming components are added.

The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess, based on zinc hexacyanocobaltate) is added to the suspension formed.

Metal salts suitable for preparation of the double metal cyanide compounds preferably have the general formula (II)

M(X)ₙ (II)

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e.

fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and r is 1 when X=halide, hydroxide, carboxylate, cyanate, thiocyanate, isocyanate, isothiocyanate or nitrate, or suitable metal salts have the general formula (IV)

M(X)ₛ (IV)

where

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b} (A)_{c} (VI)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ,(CN)_{y}]_{z} (VII)

where M is as defined in formula (II) to (V) and

M′ is as defined in formula (VI), and

x, x′, y and z are integers and are selected such as to ensure the electroneutrality of the double metal cyanide compound.

It is preferable when

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). Most preferred organic complex ligands are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or the salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the aqueous solutions of the metal salt and of the metal cyanide salt and the organic complex ligand by stirring vigorously. Optionally, the suspension formed in the first step is subsequently treated with a further complex-forming component. The complex-forming component is preferably used in a mixture with water and organic complex ligand. A preferred process for carrying out the first step (i.e. the preparation of the suspension) is effected using a mixing nozzle, particularly preferably using a jet disperser, as described in WO-A 01/39883.

In the second step, the solid (i.e. the precursor of the catalyst according to the invention) is isolated from the suspension by known techniques, such as centrifugation or filtration.

In a preferred embodiment variant, the isolated solid is subsequently washed in a third process step with an aqueous solution of the organic complex ligand (for example by resuspension and subsequent reisolation by filtration or centrifugation). Water-soluble by-products for example, such as potassium chloride, can be removed from the catalyst in this way. The amount of the organic complex ligand in the aqueous wash solution is preferably between 40% and 80% by weight, based on the overall solution.

A further complex-forming component is optionally added to the aqueous wash solution in the third step, preferably in the range between 0.5% and 5% by weight, based on the overall solution.

It is also advantageous to wash the isolated solid more than once. It is preferable when said solids are washed with an aqueous solution of the organic complex ligand (for example with an aqueous solution of the unsaturated alcohol) in a first washing step (iii-1) (for example by resuspension and subsequent reisolation by filtration or centrifugation), in order thus to remove, for example, water-soluble by-products such as potassium chloride from the catalyst. It is particularly preferable when the amount of the organic complex ligand (for example unsaturated alcohol) in the aqueous wash solution is between 40% and 80% by weight based on the overall solution for the first washing step. In the further washing steps (iii-2), either the first washing step is repeated one or more times, preferably one to three times, or, preferably, a non-aqueous solution, for example a mixture or solution of organic complex ligands (for example unsaturated alcohol) and further complex-forming component (preferably in the range between 0.5% and 5% by weight, based on the total amount of the wash solution in step (iii-2)), is used as a washing solution, and the solid is washed with it one or more times, preferably one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts from the suspension by filtration, filtercake washing and drying is described in WO-A 01/80994.

After carrying out the process according to the invention for preparing the polyethercarbonate polyol, the resulting reaction mixture generally comprises the DMC catalyst in the form of finely dispersed solid particles. It may therefore be desirable to remove the DMC catalyst as completely as possible from the resulting reaction mixture. The removal of the DMC catalyst firstly has the advantage that the resulting polyethercarbonate polyol achieves industry- or certification-relevant limits, for example in terms of metal contents or in terms of other emissions resulting from activated catalyst remaining in the product, and secondly facilitates recovery of the DMC catalyst.

The DMC catalyst may be removed very substantially or completely using various methods. The DMC catalyst can be separated from the polyethercarbonate polyol, for example, using membrane filtration (nanofiltration, ultrafiltration or crossflow filtration), using cake filtration, using precoat filtration or by centrifugation.

Preferably, removal of the DMC catalyst is accomplished by a multistage process consisting of at least two steps.

For example, in a first step, the reaction mixture to be filtered is divided in a first filtration step into a larger substream (filtrate) in which a majority of the catalyst or all the catalyst has been removed, and a smaller residual stream (retentate) comprising the removed catalyst. In a second step, the residual stream is then subjected to a dead end filtration. This affords a further filtrate stream in which a majority of the catalyst or all the catalyst has been removed, and a damp to very substantially dry catalyst residue.

Alternatively, the catalyst present in the polyethercarbonate polyol can be, however, also subjected in a first step to an adsorption, agglomeration/coagulation and/or flocculation, followed by, in a second step or a plurality of subsequent steps, the separation of the solid phase from the polyethercarbonate polyol. Suitable adsorbents for mechanical-physical and/or chemical adsorption include activated or nonactivated aluminas and fuller's earths (sepiolite, montmorillonite, talc etc.), synthetic silicates, activated carbon, silicas/diatomaceous earths and activated silicas/diatomaceous earths in typical ranges of amount of 0.1% by weight to 2% by weight, preferably 0.8% by weight to 1.2% by weight, based on the polyethercarbonate polyol, at temperatures of from 60° C. to 140° C., preferably 90° C. to 110° C., and dwell times of 20 min to 100 min, preferably 40 min to 80 min, it being possible to carry out the adsorption step, including blending of the adsorbent, in batchwise or continuous fashion.

A preferred process for separating this solid phase (consisting, for example, of adsorbent and DMC catalyst) from the polyethercarbonate polyol is precoat filtration. Here, depending on the filtration behavior which is determined by the particle size distribution of the solid phase to be removed, the average specific resistance of the resulting filtercake and the total resistance of the precoat layer and filtercake, the filter surface is coated with a permeable filtration aid (for example inorganic: celite, perlite; organic: cellulose) with a layer thickness of from 20 mm to 250 mm, preferably 100 mm to 200 mm (“pre-coat”). The majority of the solid phase (consisting, for example, of adsorbent and DMC catalyst) is removed at the surface of the precoat layer in combination with depth filtration of the smaller particles within the precoat layer. The temperature of the crude product to be filtered is in the range from 50° C. to 120° C., preferably 70° C. to 100° C.

In order to ensure a sufficient flow of product through the precoat layer and the cake layer growing thereon, the cake layer and a small part of the precoat layer may be removed (periodically or continuously) using a scraper or blade and removed from the process. This scraper/blade is moved at minimal advance rates of about 20 μm/min-500 μm/min, preferably in the range of 50 μm/min-150 μm/min.

As soon as the precoat layer has been very substantially or completely removed by this process, the filtration is stopped and a new precoat layer is applied to the filter surface. In this case, the filtration aid may be suspended, for example, in cyclic propylene carbonate.

This precoat filtration is typically conducted in vacuum drum filters. In order to achieve industrially relevant filtrate throughputs in the range from 0.1 m³/(m²·h) to 5 m³/(m²·h) in the case of a viscous feed stream, the drum filter may also be executed as a pressure drum filter with pressure differentials of up to 6 bar and more between the medium to be filtered and the filtrate side.

In principle, the DMC catalyst may be removed from the resulting reaction mixture in the process according to the invention either before removal of volatile constituents (for example cyclic propylene carbonate) or after the removal of volatile constituents.

In addition, the separation of the DMC catalyst from the resulting reaction mixture from the process of the invention may be conducted with or without the further addition of a solvent (especially cyclic propylene carbonate) for the purpose of lowering the viscosity before or during the individual steps of catalyst removal described.

In addition to the DMC catalysts preferably used based on zinc hexacyanocobaltate (Zn₃[Co(CN)₆]₂), the process according to the invention may also employ other metal complex catalysts based on the metals zinc and/or cobalt known to those skilled in the art from the prior art for the terpolymerization of epoxides and carbon dioxide. This includes in particular so-called zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284), so-called cobalt salen catalysts (described for example in U.S. Pat. No. 7,304,172 B2, US 2012/0165549 A1) and bimetallic zinc complexes with macrocyclic ligands (described for example in M. R. Kember et al., Angew. Chem., Int. Ed., 2009, 48, 931).

Alkylene Oxide:

According to the invention, the alkylene oxide comprises a proportion from 5 to 50% by weight ethylene oxide, based on the total weight of the alkylene oxide used. In general, it is possible to use alkylene oxides (epoxides) having 2-24 carbon atoms for the process according to the invention. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. In addition to ethylene oxide, the mixture preferably comprises 1-butene oxide and/or propylene oxide, especially propylene oxide, as alkylene oxides.

The proportion of ethylene oxide in the alkylene oxide is preferably 5 to 40% by weight, particularly preferably 12 to 32% by weight, based in each case on the total weight of the alkylene oxide used.

H-Functional Starter Substance:

Suitable H-functional starter substances (“starters”) used may be compounds having alkoxylation-active hydrogen atoms and having a molar mass of 18 to 4500 g/mol, preferably of 62 to 500 g/mol and more preferably of 62 to 182 g/mol. The ability to use a starter having a low molar mass is a distinct advantage over the use of oligomeric starters prepared by means of a preceding oxyalkylation. In particular an economic viability is achieved which is made possible by the omission of a separate oxyalkylation process.

Alkoxylation-active groups having active hydrogen atoms are, for example, —OH, —NH₂ (primary amines), —NH— (secondary amines), —SH, and —CO2H, preference being given to —OH and —NH₂, particular preference to —OH. H-functional starter substances used are, for example, one or more compounds selected from the group consisting of mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. Examples of C1-C24 alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol® TM products (from USSC Co.).

Mono-H-functional starter substances that may be employed include alcohols, amines, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols that may be used are: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (for example 3-methyl-1,5-pentanediol), 1,6-hexanediol, 1,8-octanediol, 1,10-decanediol, 1,12-dodecanediol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and all the modification products of these aforementioned alcohols with different amounts of ε-caprolactone.

The H-functional starter substances may also be selected from the substance class of the polyether polyols having a molecular weight Mn in the range from 18 to 4500 g/mol and a functionality of 2 to 3. Preference is given to polyether polyols formed from repeating ethylene oxide and propylene oxide units, preferably comprising a proportion of propylene oxide units of 35% to 100%, particularly preferably comprising a proportion of propylene oxide units of 50% to 100%. These may be random copolymers, gradient copolymers, alternating copolymers or block copolymers of ethylene oxide and propylene oxide.

The H-functional starter substances may also be selected from the substance class of the polyester polyols. At least bifunctional polyesters are used as the polyester polyols. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyethercarbonate polyols.

In addition, H-functional starter substances used may be polycarbonate diols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, polyethercarbonate polyols may be used as H-functional starter substances. To this end these polyethercarbonate polyols used as H-functional starter substances are prepared beforehand in a separate reaction step.

The H-functional starter substances generally have a functionality (i.e. the number of polymerization-active H atoms per molecule) of 1 to 8, preferably of 2 or 3. The H-functional starter substances are used either individually or as a mixture of at least two H-functional starter substances.

It is particularly preferable when the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, 1,6-hexanediol, 1,8-octanediol, diethylene glycol, dipropylene glycol, glycerol, trimethylolpropane, pentaerythritol, sorbitol and polyether polyols having a molecular weight Mn in the range from 150 to 4500 g/mol and a functionality of 2 to 3.

The polyethercarbonate polyols are prepared by catalytic addition reaction of carbon dioxide and alkylene oxides onto H-functional starter substances. In the context of the invention “H-functional” is understood to mean the number of alkoxylation-active hydrogen atoms per molecule of the starter substance.

Component K

Compounds suitable as component K are characterized in that they contain at least one phosphorus-oxygen bond. Examples of suitable components K are phosphoric acid and phosphoric acid salts, phosphoryl halides, phosphoric acid amides, phosphoric acid esters and salts of the mono- and diesters of phosphoric acid.

In the context of the invention, the esters cited as possible components K above and hereinafter are understood in each case to mean the alkyl ester, aryl ester and/or alkaryl ester derivatives.

Suitable phosphoric acid esters are, for example, mono-, di- or triesters of phosphoric acid, mono-, di-, tri- or tetraesters of pyrophosphoric acid and mono-, di-, tri-, tetra- or polyesters of polyphosphoric acid and alcohols having 1 to 30 carbon atoms. Examples of compounds suitable as component K include: triethyl phosphate, diethyl phosphate, monoethyl phosphate, tripropyl phosphate, dipropyl phosphate, monopropyl phosphate, tributyl phosphate, dibutyl phosphate, monobutyl phosphate, trioctyl phosphate, tris(2-ethylhexyl) phosphate, tris(2-butoxyethyl) phosphate, diphenyl phosphate, dicresyl phosphate, fructose 1,6-biphosphate, glucose 1-phosphate, bis(dimethylamido)phosphoric chloride, bis(4-nitrophenyl) phosphate, cyclopropylmethyl diethyl phosphate, dibenzyl phosphate, diethyl 3-butenyl phosphate, dihexadecyl phosphate, diisopropyl chlorophosphate, diphenyl phosphate, diphenyl chlorophosphate, 2-hydroxyethyl methacrylate phosphate, mono(4-chlorophenyl) dichlorophosphate, mono(4-nitrophenyl) dichlorophosphate, monophenyl dichlorophosphate, tridecyl phosphate, tricresyl phosphate, trimethyl phosphate, triphenyl phosphate, phosphoric acid tripyrolidide, phosphorus sulfochloride, dimethylamidophosphoric dichloride, methyl dichlorophosphate, phosphoryl bromide, phosphoryl chloride, phosphoryl quinoline chloride calcium salt and O-phosphorylethanolamine, alkali metal and ammonium dihydrogenphosphates, alkali metal, alkaline earth metal and ammonium hydrogenphosphates, alkali metal, alkaline earth metal and ammonium phosphates.

Esters of phosphoric acid (phosphoric acid esters) are also understood to mean the products obtainable by propoxylation of phosphoric acid (e.g. available as Exolit® OP 560).

Also suitable as component K are phosphonic acid and phosphorous acid and mono- and diesters of phosphonic acid and mono-, di- and triesters of phosphorous acid and respective salts thereof, halides and amides.

Examples of suitable phosphonic acid esters are mono- or diesters of phosphonic acid, alkylphosphonic acids, arylphosphonic acids, alkoxycarbonylalkylphosphonic acids, alkoxycarbonylphosphonic acids, cyanoalkylphosphonic acids and cyanophosphonic acids or mono-, di-, tri- or tetraesters of alkyldiphosphonic acids and alcohols having 1 to 30 carbon atoms. Suitable phosphorous acid esters are, for example, mono-, di- or triesters of phosphorous acid and alcohols having 1 to 30 carbon atoms. This includes, for example, phenylphosphonic acid, butylphosphonic acid, dodecylphosphonic acid, ethylhexylphosphonic acid, octylphosphonic acid, ethylphosphonic acid, methylphosphonic acid, octadecylphosphonic acid and their mono- and dimethyl esters, ethyl esters, butyl esters, ethylhexyl esters or phenyl esters, dibutyl butylphosphonate, dioctyl phenylphosphonate, triethyl phosphonoformate, trimethyl phosphonoacetate, triethyl phosphonoacetate, trimethyl 2-phosphonopropionate, triethyl 2-phosphonopropionate, tripropyl 2-phosphonopropionate, tributyl 2-phosphonopropionate, triethyl 3-phosphonopropionate, triethyl 2-phosphonobutyrate, triethyl 4-phosphonocrotonate, (12-phosphonododecyl)phosphonic acid, phosphonoacetic acid, methyl P,P-bis(2,2,2-trifluoroethyl)phosphonoacetate, trimethylsilyl P,P-diethylphosphonoacetate, tert-butyl P,P-dimethylphosphonoacetate, P,P-dimethyl phosphonoacetate potassium salt, P,P-dimethylethyl phosphonoacetate, 16-phosphonohexadecanoic acid, 6-phosphonohexanoic acid, N-(phosphonomethyl)glycine, N-(phosphonomethyl)glycine monoisopropylamine salt, N-(phosphonomethyl)iminodiacetic acid, (8-phosphonooctyl)phosphonic acid, 3-phosphonopropionic acid, 11-phosphonoundecanoic acid, pinacol phosphonate, trilauryl phosphite, tris(3-ethyloxethanyl-3-methyl) phosphite, heptakis(dipropylene glycol) phosphite, 2-cyanoethyl bis(diisopropylamido)phosphite, methyl bis(diisopropylamido)phosphite, dibutyl phosphite, dibenzyl (diethylamido)phosphite, di-tert-butyl (diethylamido)phosphite, diethyl phosphite, diallyl (diisopropylamido)phosphite, dibenzyl (diisopropylamido)phosphite, di-tert-butyl (diisopropylamido)phosphite, dimethyl (diisopropylamido)phosphite, dibenzyl (dimethylamido)phosphite, dimethyl phosphite, trimethylsilyl dimethylphosphite, diphenyl phosphite, methyl dichlorophosphite, mono(2-cyanoethyl) diisopropylamidochlorophosphite, o-phenylene chlorophosphite, tributyl phosphite, triethyl phosphite, triisopropyl phosphite, triphenyl phosphite, tris(tert-butyl-dimethylsilyl) phosphite, tris-1,1,1,3,3,3-hexafluoro-2-propyl phosphite, tris(trimethylsilyl) phosphite, dibenzyl phosphite. The term “esters of phosphorous acid” is also understood to include the products obtainable by propoxylation of phosphorous acid (available as Exolit® OP 550 for example).

Other suitable components K are phosphinic acid, phosphonous acid and phosphinous acid and their respective esters. Examples of suitable phosphinic acid esters are esters of phosphinic acid, alkylphosphinic acids, dialkylphosphinic acids or arylphosphinic acids and alcohols having 1 to 30 carbon atoms. Examples of suitable phosphonous acid esters are mono- and diesters of phosphonous acid or arylphosphonous acid and alcohols having 1 to 30 carbon atoms. This includes, for example, diphenylphosphinic acid or 9,10-dihydro-9-oxa-10-phosphaphenanthrene-10-oxide.

The esters of phosphoric acid, phosphonic acid, phosphorous acid, phosphinic acid, phosphonous acid or phosphinous acid suitable as component K are generally obtained by reaction of phosphoric acid, pyrophosphoric acid, polyphosphoric acids, phosphonic acid, alkylphosphonic acids, arylphosphonic acids, alkoxycarbonylalkylphosphonic acids, alkoxycarbonylphosphonic acids, cyanoalkylphosphonic acids, cyanophosphonic acid, alkyldiphosphonic acids, phosphonous acid, phosphorous acids, phosphinic acid, phosphinous acid or the halogen derivatives or phosphorus oxides thereof with hydroxy compounds having 1 to 30 carbon atoms such as methanol, ethanol, propanol, butanol, pentanol, hexanol, heptanol, octanol, nonanol, decanol, dodecanol, tridecanol, tetradecanol, pentadecanol, hexadecanol, heptadecanol, octadecanol, nonadecanol, methoxymethanol, ethoxymethanol, propoxymethanol, butoxymethanol, 2-ethoxyethanol, 2-propoxyethanol, 2-butoxyethanol, phenol, ethyl hydroxyacetate, propyl hydroxyacetate, ethyl hydroxypropionate, propyl hydroxypropionate, ethane-1,2-diol, propane-1,2-diol, 1,2,3-trihydroxypropane, 1,1,1-trimethylolpropane or pentaerythritol.

Phosphine oxides suitable as component K comprise one or more alkyl, aryl or aralkyl groups having 1-30 carbon atoms which are bonded to the phosphorus. Preferred phosphine oxides have the general formula R₃P═O where R is an alkyl, aryl or aralkyl group having 1-20 carbon atoms. Examples of suitable phosphine oxides are trimethylphosphine oxide, tri(n-butyl)phosphine oxide, tri(n-octyl)phosphine oxide, triphenylphosphine oxide, methyldibenzylphosphine oxide and mixtures thereof.

Also suitable as component K are phosphorus compounds that can form one or more P—O bond(s) by reaction with OH-functional compounds (such as water or alcohols). Examples of such compounds of phosphorus that are useful include phosphorus(V) sulfide, phosphorus tribromide, phosphorus trichloride and phosphorus triiodide. It is also possible to use any desired mixtures of the abovementioned compounds as component K. Component K is particularly preferably phosphoric acid.

Component K can be metered in in any desired step of the process. It is advantageous to meter in component K in step (γ), especially when H-functional starter substance is metered in in step (γ). It is also advantageous to add component K to the reaction mixture in the postreactor in step (δ). It is additionally advantageous to add component K to the reaction mixture obtained only after the postreaction (step (δ)).

In one possible embodiment of the invention, during the postreaction (step (δ)), component K is added in an amount of 5 ppm to 1000 ppm, particularly preferably 10 ppm to 500 ppm, most preferably 20 ppm to 200 ppm, based in each case on the reaction mixture obtained in step (γ). Component K is added during the postreaction more preferably at a free alkylene oxide content of 0.1 g/L to 10 g/L, most preferably of 1 g/L to 10 g/L, alkylene oxide and most especially preferably of 5 g/L to 10 g/L. When conducting the process according to the invention using a tubular reactor for the postreaction in step (δ), component K is particularly preferably metered in in the second half of the distance that the reaction mixture traverses in the tubular reactor.

The polyether carbonate polyols obtained in accordance with the invention have a functionality, for example, of at least 1, preferably of 1 to 8, more preferably of 1 to 6 and most preferably of 2 to 4. The molecular weight is preferably 400 to 10 000 g/mol and more preferably 500 to 6000 g/mol.

### EXPERIMENTAL SECTION

### EXAMPLES

The present invention will be further elucidated with reference to the following examples. For the examples, a DMC catalyst prepared according to Example 6 in WO 01/80994 Al was used and a difunctional polyether polyol having an OH number of 260 mg KOH/g was used as the H-functional starter substance.

Test Methods:

The viscosity was determined using a rotational viscometer (Physica MCR501 from Anton Paar) based on the specification DIN 53019 (from 2008) using a parallel plate measuring system (25 mm diameter) at 25° C. and a shear rate of 403 Hz.

The proportion of CO₂ incorporated in the resulting polyethercarbonate polyol (CO₂ content) was determined by ¹H-NMR on a Bruker spectrometer (AV400, 400 MHz). The samples were dissolved in deuterated chloroform. The relevant resonances in the ¹H-NMR (relative to CDCl₃=7.26 ppm) are as follows:
F(I): Area of resonance at 1.17-0.90 ppm corresponds to 3 H atoms of the polypropylene oxide (PPO) units in the polyol
F(II): Area of resonance at 1.34-1.17 ppm corresponds to 3 H atoms of the polypropylene carbonate (PPC) units in the polyol
F(III): Area of resonance at 3.80-3.04 ppm corresponds to 3 H atoms of the PPO units and 4 H atoms of the polyethylene oxide (PEO) units in the polyol
F(IV): Area of resonance at 4.33-4.13 ppm corresponds to 2 H atoms of the polyethylene carbonate (PEC) units in the polyol

The relative mole fractions (x) in the polyol are determined as follows:
x(PPO)=F(I)/3
x(PPC)=F(II)/3
x(PEO)=(F(III)−F(I))/4
x(PEC)=F(IV)/2

The composition of the polyol determined in this way is then converted into parts by weight and normalized to 100. The following molar masses are used for the conversion: PPO=58.08 g/mol, PPC=102.09 g/mol, PEO=44.05 g/mol, PEC=88.06 g/mol. The CO₂ content is then calculated using the proportions of the carbonate units and the molar mass of CO₂ (44.01 g/mol):

$$\% by wt . ( CO 2 ) = \% by wt . ( PPC ) \frac{44.01}{102.09} + \% by wt . ( PEC ) \frac{44.01}{88.06}$$

To determine the proportions of the primary OH groups, 1 mL of trifluoroacetic anhydride was added to 0.2 g of polyol and the mixture was stirred at 35° C. overnight. All volatile compounds were then removed under high vacuum (<1 mbar) and the functionalized polyol was characterized by ¹⁹F-NMR. The signal in the range from −74.897 ppm to 75.191 ppm is attributable to trifluoroacetic acid esterified with a primary OH group, while the signal in the range from −75.266 ppm to 75.481 ppm is attributable to trifluoroacetic acid esterified with a secondary OH group. The respective proportion can then be determined via the ratio of the integrals to one another.

### Example 1a: Preparation of a Polyether Polyol by Copolymerization of EO and PO at an EO/PO Ratio by Weight of 30/70

(α) In a 300 mL pressure reactor equipped with gas and liquid metering devices, 27.6 mg of non-activated DMC catalyst were suspended in 30 g of H-functional starter substance. The suspension was heated to 130° C. with stirring (1000 rpm) and a stream of argon was additionally passed through an immersion tube at a pressure of 50 mbar.
(β) Subsequently, 2.5 bar argon was injected and the catalyst was activated. For this purpose, 3×3 g of the alkylene oxide mixture having an EO/PO ratio by weight of 30/70 were added in pulses (5 mL/min). Between the pulses there was a 10 minute interval for the alkylene oxides to completely react.
(γ) Thereafter, the temperature was lowered to 100° C. The remaining 99 g of the alkylene oxide mixture having an EO/PO ratio by weight of 30/70 were added over the course of 1 hour at a metering rate of 2 mL/min. After the addition of alkylene oxide was complete, the mixture was stirred for a further 2 hours to ensure that all of the alkylene oxides had reacted. The reactor was then depressurized and cooled to room temperature.

In order to remove by-products, the polyether polyol produced was purified using a thin-film evaporator at 130° C. Table 1 shows the results of the viscosity measurement and the determination of the primary OH groups.

### Example 1b: Preparation of a Polyether Polyol by Copolymerization of EO and PO at an EO/PO Ratio by Weight of 20/80

The process was carried out according to Example la using an alkylene oxide mixture at an EO/PO ratio by weight of 20/80.

### Example 1c: Preparation of a Polyether Polyol by Copolymerization of EO and PO at an EO/PO Ratio by Weight of 10/90

The process was carried out according to Example la using an alkylene oxide mixture at an EO/PO ratio by weight of 10/90.

### Example 2a: Preparation of a Polyethercarbonate Polyol by Terpolymerization of CO₂, EO and PO at an EO/PO Ratio by Weight of 30/70 and a CO₂ Pressure of 5 Bar

(α) In a 300 mL pressure reactor equipped with gas and liquid metering devices, 27.6 mg of non-activated DMC catalyst were suspended in 30 g of H-functional starter substance. The suspension was heated to 130° C. with stirring (1000 rpm) and a stream of argon was additionally passed through an immersion tube at a pressure of 50 mbar.
(β) Subsequently, 2.5 bar argon was injected and the catalyst was activated. For this purpose, 3×3 g of the alkylene oxide mixture were added in pulses (5 mL/min). Between the pulses there was a 10 minute interval for the alkylene oxides to completely react.
(γ) The atmosphere was then changed to CO₂ (5 bar) and the temperature lowered to 100° C. The remaining 99 g of the alkylene oxide mixture were added over the course of 1 hour at a metering rate of 2 mL/min. The course of the reaction was observed by means of CO₂ consumption, while keeping the pressure in the reactor constant by continuous further metered addition of CO₂. After the addition of alkylene oxide was complete, the mixture was stirred for a further 2 hours to ensure that all of the alkylene oxides had reacted. The reactor was then depressurized and cooled to room temperature.

In order to remove by-products, the polyethercarbonate polyol produced was purified using a thin-film evaporator at 130° C. Table 1 shows the results of the viscosity measurement and the determination of the primary OH groups.

### Example 2b: Preparation of a Polyethercarbonate Polyol by Terpolymerization of CO₂, EO and PO at an EO/PO Ratio by Weight of 20/80 and a CO₂ Pressure of 5 Bar

The process was carried out according to Example 2a using an alkylene oxide mixture at an EO/PO ratio by weight of 20/80.

### Example 2c: Preparation of a Polyethercarbonate Polyol by Terpolymerization of CO₂, EO and PO at an EO/PO Ratio by Weight of 10/90 and a CO₂ Pressure of 5 Bar

The process was carried out according to Example 2a using an alkylene oxide mixture at an EO/PO ratio by weight of 10/90.

### Example 3a: Preparation of a Polyethercarbonate Polyol by Terpolymerization of CO₂, EO and PO at an EO/PO Ratio by Weight of 30/70 and a CO₂ Pressure of 10 Bar

(α) In a 300 mL pressure reactor equipped with gas and liquid metering devices, 27.6 mg of non-activated DMC catalyst were suspended in 30 g of H-functional starter substance. The suspension was heated to 130° C. with stirring (1000 rpm) and a stream of argon was additionally passed through an immersion tube at a pressure of 50 mbar.
(β) Subsequently, 2.5 bar argon was injected and the catalyst was activated. For this purpose, 3×3 g of the alkylene oxide mixture were added in pulses (5 mL/min). Between the pulses there was a 10 minute interval for the alkylene oxides to completely react.
(γ) The atmosphere was then changed to CO₂ (10 bar) and the temperature lowered to 100° C. The remaining 99 g of the alkylene oxide mixture were added over the course of 1 hour at a metering rate of 2 mL/min. The course of the reaction was observed by means of CO₂ consumption, while keeping the pressure in the reactor constant by continuous further metered addition of CO₂. After the addition of alkylene oxide was complete, the mixture was stirred for a further 2 hours to ensure that all of the alkylene oxides had reacted. The reactor was then depressurized and cooled to room temperature.

In order to remove by-products, the polyethercarbonate polyol produced was purified using a thin-film evaporator at 130° C. Table 1 shows the results of the viscosity measurement and the determination of the primary OH groups.

### Example 3b: Preparation of a Polyethercarbonate Polyol by Terpolymerization of CO₂, EO and PO at an EO/PO Ratio by Weight of 20/80 and a CO₂ Pressure of 10 Bar

The process was carried out according to Example 3a using an alkylene oxide mixture at an EO/PO ratio by weight of 20/80.

### Example 3c: Preparation of a Polyethercarbonate Polyol by Terpolymerization of CO₂, EO and PO at an EO/PO Ratio by Weight of 10/90 and a CO₂ Pressure of 10 Bar

The process was carried out according to Example 3a using an alkylene oxide mixture at an EO/PO ratio by weight of 10/90.

### Example 4a: Preparation of a Polyethercarbonate Polyol by Terpolymerization of CO₂, EO and PO at an EO/PO Ratio by Weight of 30/70 and a CO₂ Pressure of 25 Bar

(α) In a 300 mL pressure reactor equipped with gas and liquid metering devices, 27.6 mg of non-activated DMC catalyst were suspended in 30 g of H-functional starter substance. The suspension was heated to 130° C. with stirring (1000 rpm) and a stream of argon was additionally passed through an immersion tube at a pressure of 50 mbar.
(β) Subsequently, 2.5 bar argon was injected and the catalyst was activated. For this purpose, 3×3 g of the alkylene oxide mixture were added in pulses (5 mL/min). Between the pulses there was a 10 minute interval for the alkylene oxides to completely react.
(γ) The atmosphere was then changed to CO₂ (25 bar) and the temperature lowered to 100° C. The remaining 99 g of the alkylene oxide mixture were added over the course of 1 hour at a metering rate of 2 mL/min. The course of the reaction was observed by means of CO₂ consumption, while keeping the pressure in the reactor constant by continuous further metered addition of CO₂. After the addition of alkylene oxide was complete, the mixture was stirred for a further 2 hours to ensure that all of the alkylene oxides had reacted. The reactor was then depressurized and cooled to room temperature.

In order to remove by-products, the polyethercarbonate polyol produced was purified using a thin-film evaporator at 130° C. Table 1 shows the results of the viscosity measurement and the determination of the primary OH groups.

### Example 4b: Preparation of a Polyethercarbonate Polyol by Terpolymerization of CO₂, EO and PO at an EO/PO Ratio by Weight of 20/80 and a CO₂ Pressure of 25 Bar

The process was carried out according to Example 3a using an alkylene oxide mixture at an EO/PO ratio by weight of 20/80.

### Example 4c: Preparation of a Polyethercarbonate Polyol by Terpolymerization of CO₂, EO and PO at an EO/PO Ratio by Weight of 10/90 and a CO₂ Pressure of 25 Bar

The process was carried out according to Example 3a using an alkylene oxide mixture at an EO/PO ratio by weight of 10/90.

TABLE 1

| | | Proportion of | | | |
|---|---|---|---|---|---|
| | | ethylene oxide | | Primary | |
| | CO₂ | in the alkylene | CO₂ | OH | Vis- |
| Exam- | pressure | oxide used [% | content [% | groups | cosity |
| ple | [bar] | by weight] | by weight¹] | [%] | [mPas*s] |
| 1a* | 0 | 30 | 0 | 18.6 | 187.6 |
| 1b* | 0 | 20 | 0 | 17.3 | 174.3 |
| 1c* | 0 | 10 | 0 | 14.5 | 177.2 |
| 2a | 5 | 30 | 2.9 | 24.2 | 209.6 |
| 2b | 5 | 20 | 3.0 | 21.3 | 191.1 |
| 2c | 5 | 10 | 3.8 | 19.3 | 256.9 |
| 3a | 10 | 30 | 6.3 | 27.0 | 325.4 |
| 3b | 10 | 20 | 6.1 | 24.2 | 297.1 |
| 3c | 10 | 10 | 6.9 | 20.0 | 366.5 |
| 4a | 25 | 30 | 9.7 | 32.0 | 469.5 |
| 4b | 25 | 20 | 10.5 | 26.0 | 530.9 |
| 4c | 25 | 10 | 11.3 | 20.6 | 622.9 |

*comparative example
¹% by weight based on the total weight of the polyethercarbonate polyol

The results show that when a mixture of at least two alkylene oxides comprising ethylene oxide in a ratio by weight of 5 to 50% by weight, based on the total weight of the alkylene oxide used, is added onto an H-functional starter substance under a carbon dioxide-containing atmosphere in accordance with the invention, this results in improved incorporation of primary OH groups.

1. A process for preparing polyethercarbonate polyols by addition of alkylene oxide and carbon dioxide onto an H-functional starter substance in the presence of a DMC catalyst or a metal complex catalyst based on the metals cobalt and/or zinc, wherein
(γ) alkylene oxide and carbon dioxide are added onto an H-functional starter substance in a reactor in the presence of a DMC catalyst or a metal complex catalyst based on the metals cobalt and/or zinc;
wherein the alkylene oxide comprises a proportion of from 5 to 50% by weight ethylene oxide, based on the total weight of the alkylene oxide used, and the addition of the ethylene oxide is carried out under a carbon dioxide-containing atmosphere.

2. The process as claimed in claim 1, wherein prior to step (γ):
(α) an H-functional starter substance or a suspension medium is initially charged into the reactor.

3. The process as claimed in claim 2, wherein the suspension medium used is 4-methyl-2-oxo-1,3-dioxolane, 1,3-dioxolan-2-one, toluene, xylene, ethylbenzene, chlorobenzene, dichlorobenzene or any combination thereof.

4. The process as claimed in claim 1, wherein in step (γ), the ethylene oxide is present in an amount of 5 to 40% by weight based on the total weight of the alkylene oxide used.

5. The process as claimed in claim 1, wherein in step (γ), the carbon dioxide is used at a pressure of 2.5 to 100 bar.

6. The process as claimed in claim 1, wherein the H-functional starter substances used are one or more compounds selected from the group consisting of ethylene glycol, propylene glycol, 1,3-butanediol, 1,4-butanediol, 1,5-pentanediol, 2-methylpropane-1,3-diol, neopentyl glycol, 1,6-hexanediol, 1,8-octanediol, diethylene glycol, dipropylene glycol, glycerol, trimethylolpropane, pentaerythritol, sorbitol and polyether polyols having a molecular weight Mₙ in the range of 150 to 4500 g/mol and a functionality of 2 to 3.

7. A polyethercarbonate polyol prepared by the process as claimed in claim 1.

8. A method for producing polyurethane plastics with the polyethercarbonate polyol as claimed in claim 7.

9. The process as claimed in claim 2, wherein in step (α), the H-functional starter substance or the suspension medium is initially charged into the reactor and water and/or other highly volatile compounds are removed by drying at elevated temperature and/or reduced pressure, wherein the catalyst is added to the H-functional starter substance or the suspension medium before or after drying.

10. The process as claimed in claim 2, wherein prior to step (γ):
(β) for activation of the DMC catalyst a proportion of the alkylene oxide, based on the total amount of alkylene oxide used in the activation and terpolymerization, is added to the mixture resulting from step (α), wherein this addition of a portion of alkylene oxide may optionally be carried out in the presence of CO₂, and wherein the temperature spike occurring on account of the subsequent exothermic chemical reaction and/or a pressure drop in the reactor is then awaited in each case, and wherein step (β) for activation may also be carried out two or more times.

11. The process as claimed in claim 4, wherein in step (γ), the ethylene oxide is present at an amount of 12 to 32% by weight, based on the total weight of the alkylene oxide used.

12. The process as claimed in claim 5, wherein in step (γ), the carbon dioxide is used at a pressure of 8 to 30 bar.

13. The method as claimed in claim 8, wherein the polyurethane plastics comprise polyurethane foams.
